(19) United States
(12) Patent Application Publication
(10) Pub. No.: US 2019/0186354 A1
(43) Pub. Date: Jun. 20, 2019

(54) Internal Combustion Engine

(71) Applicant: ecool Advanced Urban Engineering GMBH, Vienna (AT)

(72) Inventors: Ursula Hofbauer, Vienna (AT); Adrian Tusinean, Windsor (CA)

(73) Assignee: ecool Advanced Urban Engineering GMBH, Vienna (AT)

(21) Appl. No.: 16/326,197

(22) PCT Filed: Aug. 17, 2017
(86) PCT No.: PCT/AT2017/060202

§ 371 Date: Feb. 17, 2019

(30) Foreign Application Priority Data
Aug. 18, 2016 (AT) A 50743/2016

(51) Int. Cl. F02B 75/28

(52) U.S. Cl. CPC F02B 75/282; F16H 21/18

(57) ABSTRACT

The disclosure relates to an internal combustion engine (1) with at least one double cylinder (2), in which two inner pistons (6) and two outer pistons (7) are arranged such that they reciprocate in the double cylinder (2) by at least one respective inner connecting rod (8) or a respective first outer connecting rod (11a) and a respective second outer connecting rod (11b) with the aid of a crankshaft (4). The present disclosure provides an internal combustion engine (1) in which the outer connecting rods do not pivot. The two first outer connecting rods (11a) of the two outer pistons (7) are coaxial and integrally formed; and the two second outer connecting rods (11b) are coaxial and integrally formed.

### FIELD

The present disclosure relates to an internal combustion engine with at least one double cylinder, in which two inner pistons and two outer pistons are arranged such that they can be moved back and forth in the double cylinder by at least one respective inner connecting rod or a respective first outer connecting rod and a respective second outer connecting rod by a crankshaft.

The double cylinder has two opposing cylinders which are on the same axis. These cylinders each have opposing pistons.

### BACKGROUND

An internal combustion engine with coaxial cylinders with inner and outer pistons is disclosed in US 2015/0114358 A1. It consists of a first outer piston over a swiveling main connecting rod connected to a crankshaft journal and a second outer piston is arranged coaxially to the first outer piston. The second outer piston is connected to a swiveling auxiliary connecting rod, which is connected to the crankshaft via the main connecting rod. A disadvantage of this method is that the pivoting movement of the main and auxiliary connecting rods introduces transverse forces into the outer piston and the crankshaft. Furthermore, the pivoting movement also creates the need for a space between the outer pistons and the connecting rods.

Assemblies with fixed inner connecting rods with two arranged on a crankshaft with one piston each are described by Parson's Engine for simple double-cylinder piston engines. This version only moves the pistons and the connecting rods translationally along a straight line. For a four-cylinder engine a transfer disc is installed in front of the first crank throw. A second transfer disc is arranged between the two cylinders and a third transfer disc is installed after the second crank throw. Each of the two ends of the crankshaft have an externally toothed gear. Each of these gears engage with a ring gear. Due to the many parts needed and the complicated construction, this arrangement is not ideal.

In other purely kinematic solutions, which are hardly used, things such as crank grinding can result high loads and bearing friction. This means the components must be very robust to survive.

An internal combustion engine that eliminates these disadvantages and maintains high efficiency is desired.

### SUMMARY

According to the disclosure, this purpose is achieved by arranging the first two outer connecting rods and the two outer pistons coaxially and preferably of one piece, and that the two second outer connecting rods are coaxial and preferably of one piece. The advantage of this is that no pivoting movement is necessary, which avoids the lateral forces introduced into the pistons and piston pins. Consequently, it also prevents excessive stress and wear. Each outer piston can be directly connected to its respective connecting rod without the need for an articulated connection. Furthermore, there is no longer a need for a piston sleeve to better guide the pistons in the cylinder. Since the friction on the piston is largely attributable to the lateral forces, the friction is significantly reduced.

As no bending forces are created by lateral acceleration of the outer connecting rods as they are with pivoting connecting rods, the outer connecting rods can be radial to the cylinder and flat, thus saving space and weight. The conserved space can be used for the gas exchange.

The outer connecting rods are rigidly connected. It is possible to make them all one piece. The two first outer connecting rods and the two second outer connecting rods are each connected to the crankshaft by a circular bearing.

Another advantage of this arrangement is that it reduces inertial forces, especially those of higher order. These forces are less of an issue for the inner connecting rods, since they are shorter.

By eliminating the lateral forces, the design also avoids tribological problems with friction and lubrication that occur in the conventional piston design. The disclosed design can use a simple cylindrical outer piston without an oval shape or crowning.

Because the outer connecting rods do not need to pivot, the space required for this pivoting can be saved. This space can instead be used for passages for intake and exhaust flows, i.e. gas exchange.

The first outer connecting rods are connected to the crankshaft via a first transfer disc that rotates relative to the connecting rods; and the second outer connecting rods are connected to the crankshaft via a second transfer disc that rotates relative to the connecting rods. The first and second transfer discs are attached eccentrically to an outer crankshaft journal of the crankshaft such that they can rotate. Both transfer discs are installed in the circular bearings of the outer connecting rods.

An advantage of this design is that due to the geometry, the eccentricity of the crankshaft journal amounts to only a quarter of a stroke, which is only half of that of the conventional crank drive, in which it is half a stroke distance.

Reducing the eccentricity by half compared to the conventional crank mechanism greatly improves the overlap between the main bearing of the crankshaft and the following crankshaft journals. The crankshaft itself is therefore much stiffer and sturdier and can be made more compact and at lower manufacturing cost.

Another advantage is that the piston movement is naturally harmonic; i.e. it is sinusoidal. The total mass can be easily balanced with counterweights on the crankshaft and transfer disc.

The transfer discs in the outer rods can be installed, for example, in a sliding bearing or in a roller bearing. This is because of the manageable loads on the bearings in this area, as well as the possible sliding and rolling speeds. No sliding or linear bearings are necessary.

In some embodiments, external teeth on the transfer disc engage with internal teeth of a ring gear, which is fixed to the external housing. The external teeth and the internal teeth have a gear ratio of 1:2.

A particularly simple arrangement is created when the first longitudinal axis of the first outer connecting rods, the second longitudinal axis of the second outer connecting rods, and the stroke axis of the outer piston and the inner piston all lie in a single plane.

No articulated connection is needed between the outer connecting rods and the outer piston. The arrangement is particularly simple and robust with the two outer pistons fully fixed to the first and second outer connecting rods.

This is particularly simple because the first and second outer connecting rods are connected both to each other and to the outer piston via a T-shaped component. The two first and the two second outer connecting rods and the two T-shaped connecting components form a unit with the two outer pistons. These individual parts move as a unit, with no need for movement relative to each other.

An accurate guide for the outer piston is created by the T-shaped connecting element with its two ends in the guide recesses of each cylinder of the double cylinder, wherein the two ends are installed parallel to the level sliding surfaces.

To avoid pivoting movement of the inner connecting rods, in some embodiments, both inner connecting rods to be of one piece and attached to the crankshaft by a third transfer disc, wherein the third transfer disc is arranged eccentrically to an inner crankshaft journal, and is attached to both the crankshaft and the inner connecting rods in a rotating fashion.

A simpler method of assembly can be developed by creating the crank arm portion of the crankshaft out of at least two individual parts, with two conical surfaces, connected with bolts or stud bolts.

The assembly can be further simplified by using stud bolts that have two sections of thread. Each section would have a different pitch, and the pitch of the second section is larger than that of the first section. The first section of thread is inserted into the crank arm, and the second section of thread is screwed into its respective crankshaft journal.

### BRIEF DESCRIPTION OF THE DRAWINGS

The disclosure is explained more thoroughly by the following non-limiting figures.

FIGS. 1, 2, 4, 5, and 6 are views of an internal combustion engine from a first isometric view, a second isometric view, a top view, a front view, and a side view, respectively;

FIG. 3 Is a cross section of the internal combustion engine of FIGS. 1, 2, 4, 5, and 6;

FIG. 7 is a side view of a first outer connecting rod with a first transfer disc and a ring gear;

FIG. 8 is an isometric view of the crankshaft, connecting rods, and ring gears of the internal combustion engine of FIGS. 1, 2 4-6;

FIG. 9 a top view of the internal combustion engine without the cylinders or housing;

FIG. 10 shows a second embodiment of an internal combustion engine according to embodiments of the disclosure in cross section.

FIG. 11 is a schematic sketch of the crankshaft in a side view;

FIG. 12a is a schematic sketch of the crankshaft in side view;

FIG. 12b shows a cardanic circle pair of FIG. 12a;

FIG. 12c shows the crankshaft and an outer crankshaft journal of FIG. 12a;

FIG. 12 d shows the first transfer disk of FIG. 12a;

FIGS. 13a-3 are schematic sketches of the crankshaft in the side view in first, second, third, fourth, and fifth positions;

FIG. 14 a schematic sketch of a side view of the first transfer disc;

FIG. 15 a schematic representation of the forces on the internal combustion engine;

FIG. 16 a third example of the internal combustion engine; and

FIG. 17 the crankshaft of a fourth example of the internal combustion engine.

### DETAILED DESCRIPTION

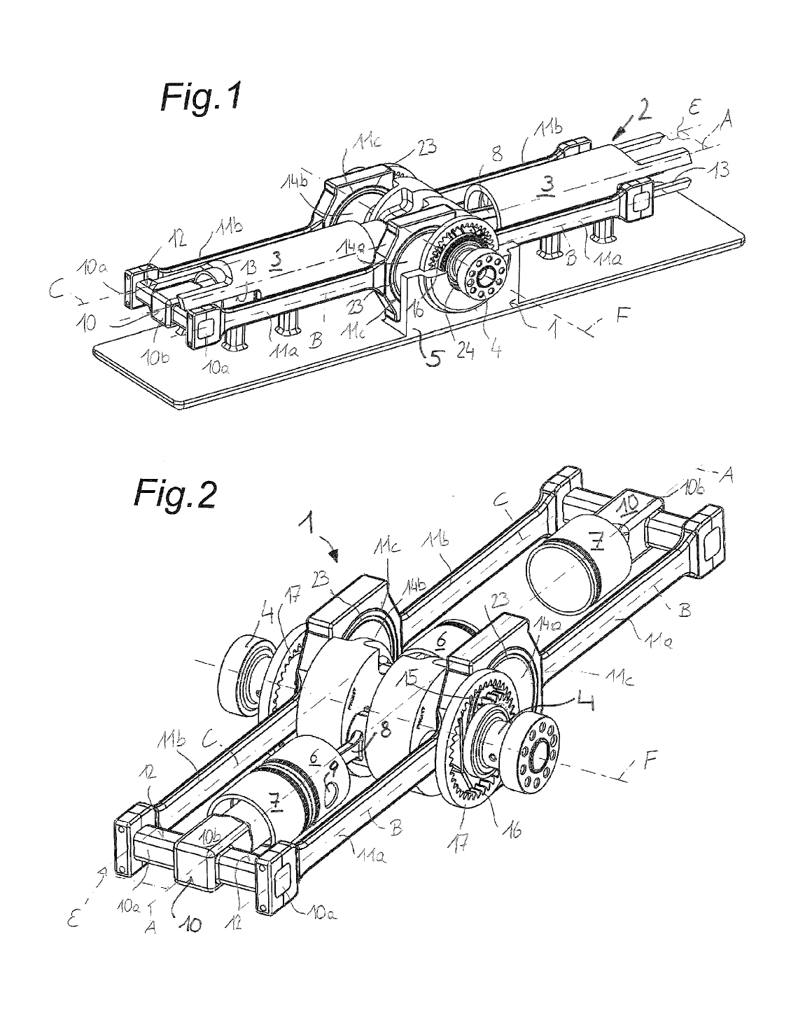

FIG. 1 shows a first example of an internal combustion engine 1 disclosed herein. Engine 1 has a double cylinder 2. Each cylinder 3 of double cylinder 2 is situated along a central stroke axis, A, on either side of a crankshaft 4. Crankshaft 4 is mounted so that is able to rotate in a housing 5. Cylinders 3 are attached to housing 5.

In each cylinder 3 of double cylinder 2, there is an inner piston 6 and an outer piston 7, as shown in FIG. 2. The two inner pistons 6 and the two outer pistons 7 reciprocate in their associated cylinder 3, opposite each other along the central stroke axis, A.

Inner pistons 6 are attached via two inner connecting rods 8 to the rotating crankshaft 4. The inner connecting rods 8 are each connected via a piston pins 9 in such a manner that they can pivot.

Outer pistons 7 are each connected to a first outer connecting rod 11a and a second outer connecting rod 11b via a T-shaped connecting component 10. To further counteract any tilting movement of the outer piston 7, two ends 10a of T-shaped connecting element 10 connected to outer connecting rods 11a, 11b. T-shaped connecting element has a middle body 10b and sliding surfaces 12. Each T-shaped element 10 is guided by recessed slots 13 (FIG. 1) in each cylinder 3 to keep them parallel to the central stroke axis, A.

One pair of outer connecting rods pairs 11a are arranged coaxially along a first axis, B, which is parallel to stroke axis, A, of inner piston 6 and outer piston 7. The other pair of outer connecting rods 11b are arranged on a second axis, C, which is also parallel to the central stroke axis, A.

Outer connecting rods 11a are attached to crankshaft 4 via a first transfer disc 14a in such a way that the disc may rotate. Outer connecting rods 11b are attached analogously to a second transfer disc 14b. Transfer discs 14a, 14b may be mounted so that they slide or roll. Transfer discs 14a, 14b have external teeth 15. These external teeth 15 are arranged to engage inner teeth 16 of a ring gear 17.

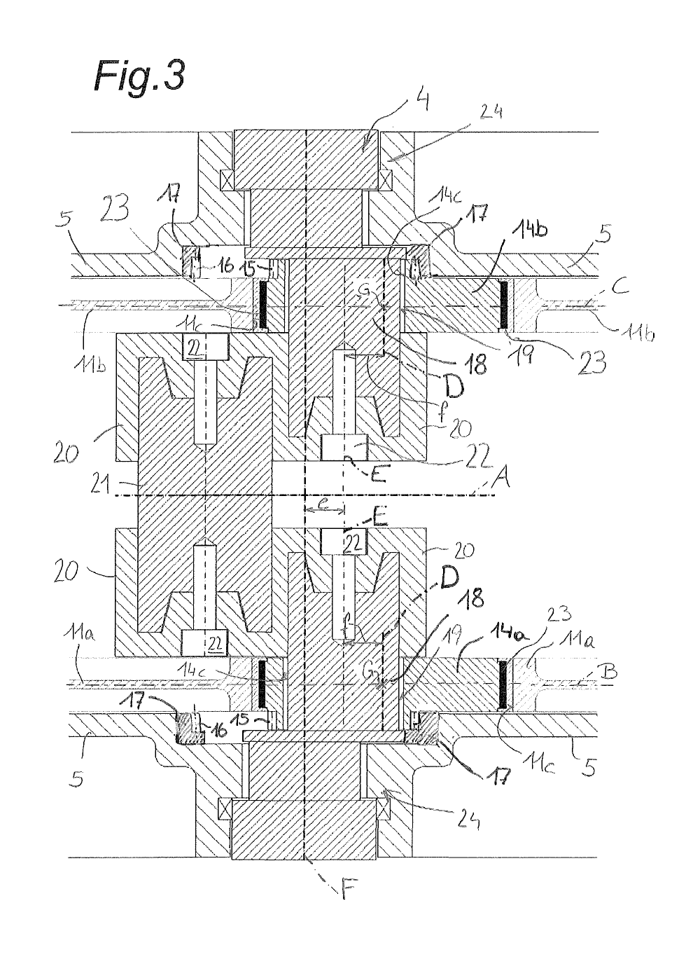

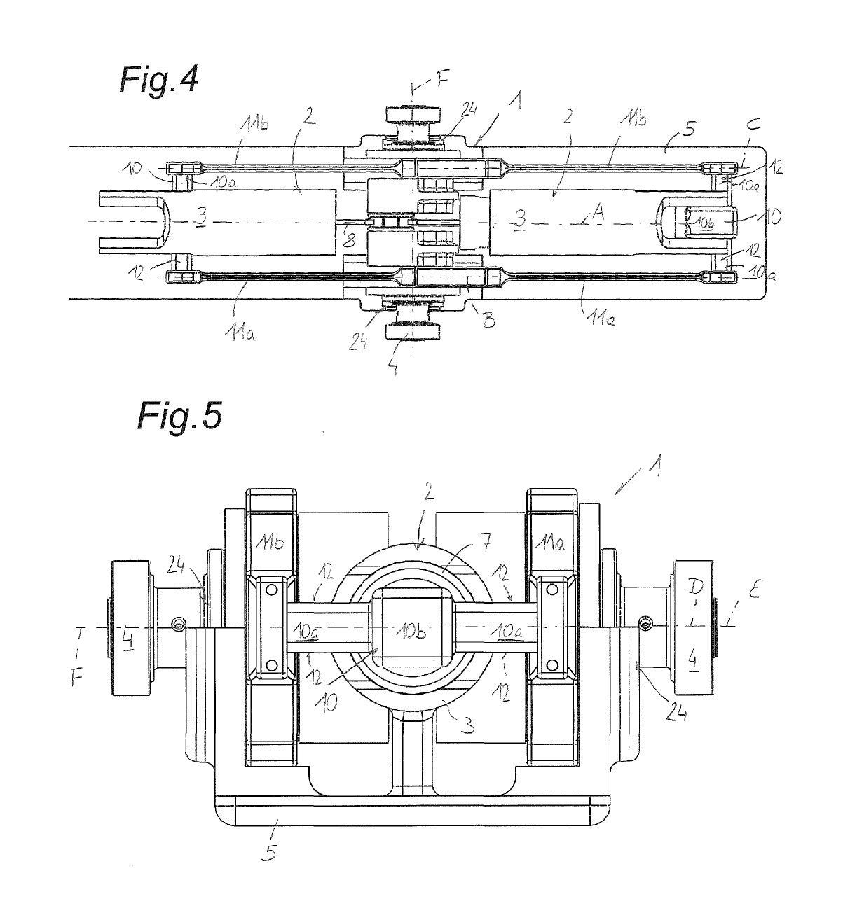

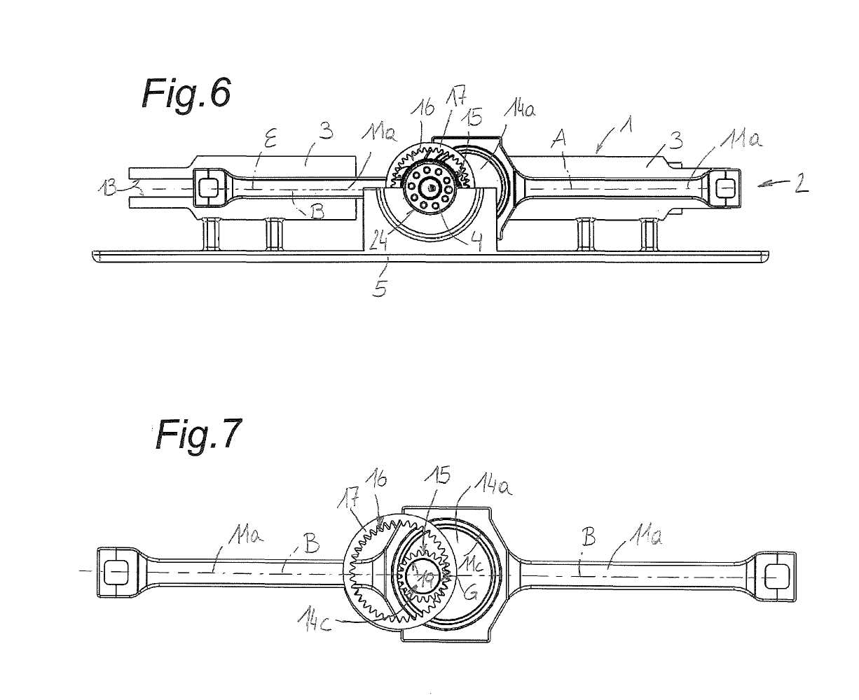

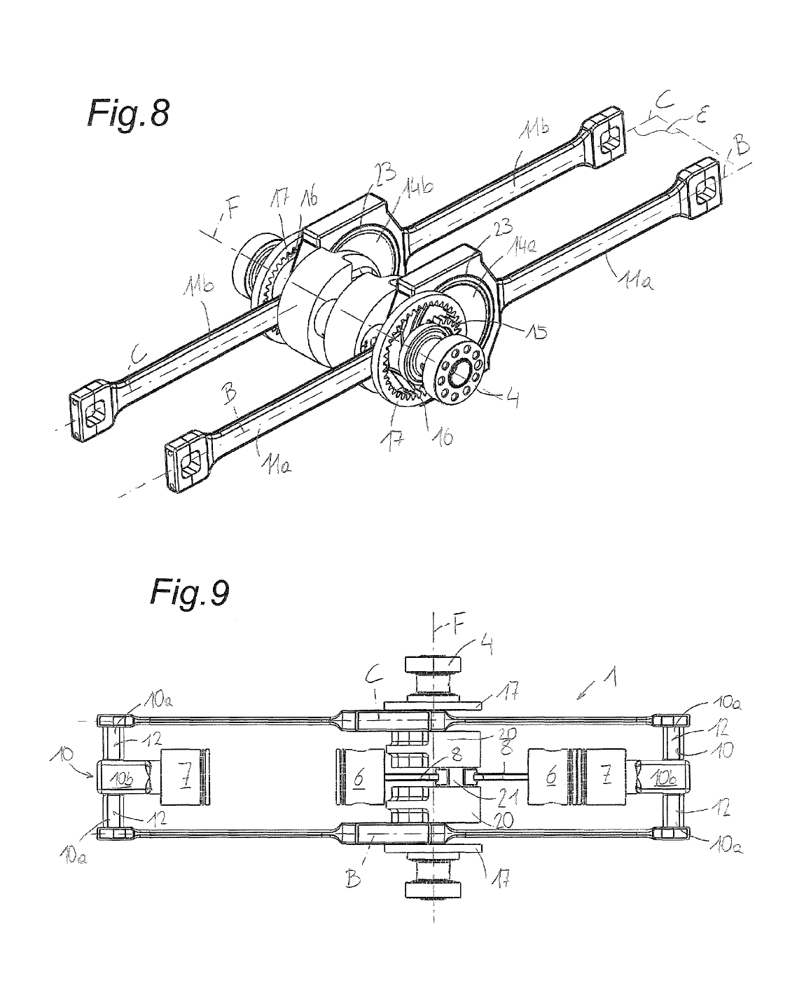

Referring now to FIG. 3, transfer discs 14a, 14b each rotate on an outer crankshaft journal 18 of crankshaft 4. They are eccentric. The rotational axis, D, of transfer discs 14a, 14b are offset from a rotational axis, E, of outer crankshaft journal 18. The term rotational axis D, E refers to the axis of of rotational symmetry, not to rotation of the body in question (crankshaft journal 18 or transfer discs 14a, 14b).

Each outer crankshaft journal 18 has a respective transfer disc 14a, 14b designed as an outer crankshaft bearing surface 19. Crankshaft 4 is bolted together in the area of the crank arms 20. The individual parts can also be coupled by an equivalent bonding agent, or it can be of one piece. This allows outer crankshaft journals 18 to be press-fit into transfer discs 14a, 14b and allowing outer connecting rods 11a, 11b to be one piece.

Between the two crank arms 20, there is an inner crankshaft journal 21. In the example shown, it is connected to the crank arms 20 via bolts 22.

Outer connecting rods 11a, 11b are each connected to transfer discs 14a, 14b via a roller bearing 23 in the example shown in FIG. 3.

Stroke axis, A, of inner piston 6 and outer piston 7, the first longitudinal axis, B, and the second longitudinal axis, C, lie in a plane, E, which represents the section plane of FIG. 3.

Crankshaft 4 is mounted in housing 5 such that it can rotate about an axis, F. Ring gear 17 is fixed in housing 5. The axis, F, is also the axis of rotational symmetry of ring gear 17.

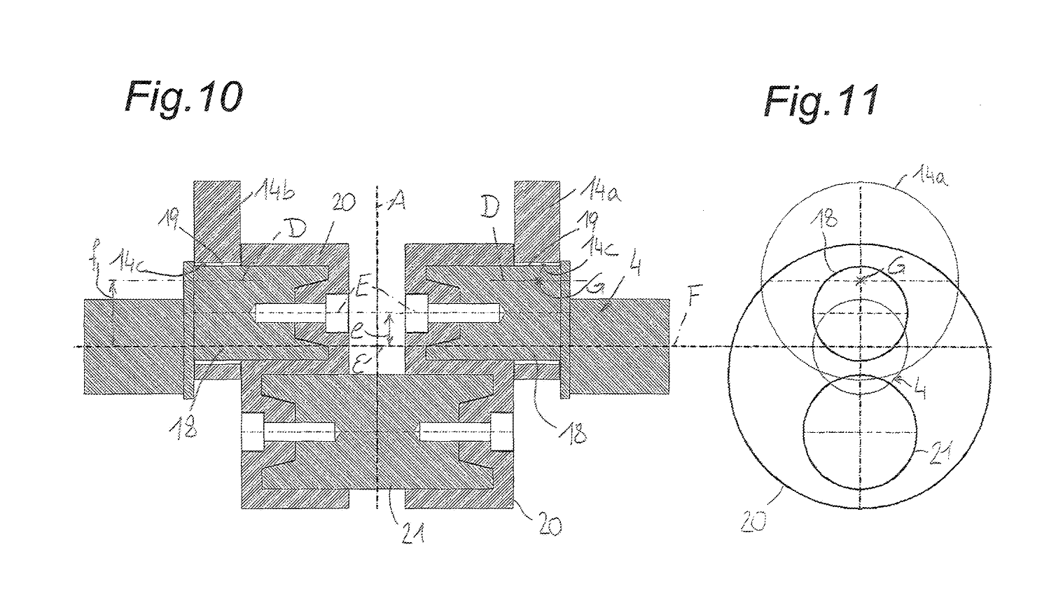

FIGS. 10 and 11 show a second example of the internal combustion engine 1. In this example, first transfer disc 14a and second transfer disc 14b have no external teeth. Outer crankshaft journal 18 is attached such that it can slide in an eccentric recess 14c of transfer discs 14a, 14b.

Kinematically, the internal combustion engine of this disclosure is based on the cardanic circle pair: if one places an inner, smaller circle along an outer, larger circle with double the radius of the inner, as the small circle moves, each point of it is straight on the diameter of the larger circle.

Philippe de La Hire first proved in 1706 that the hypotrochoids of cardanic circles are all ellipses. When the ratio of the larger cardanic circle, a, to the smaller cardanic circle, b, is 2:1, and the smaller circle, b, is rolling inside the larger circle, a, each point that is rotated through by the smaller circle, b, describes an ellipse. If the point of rotation lies within the circle, b, the ellipse also lies completely inside the larger circle, a. If the point of rotation lies outside of the smaller circle, b, the ellipse is partly outside of the larger circle, a. In the special case where the point of rotation is exactly on the circumference of the smaller circle, b, it moves on a straight line, namely on a diameter of the larger circle, a.

This straight line can be understood as a degenerated ellipse, and this particular geometric case is of importance for the disclosed engine. This special case makes it possible to translate the oscillating movement of the outer connecting rods into a rotational movement.

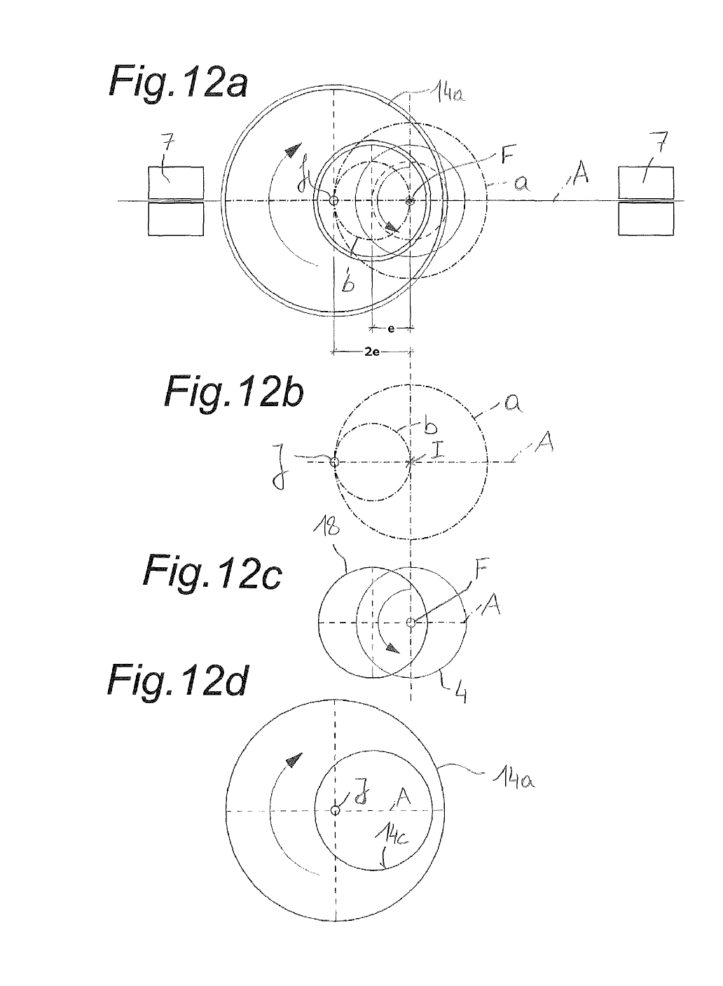

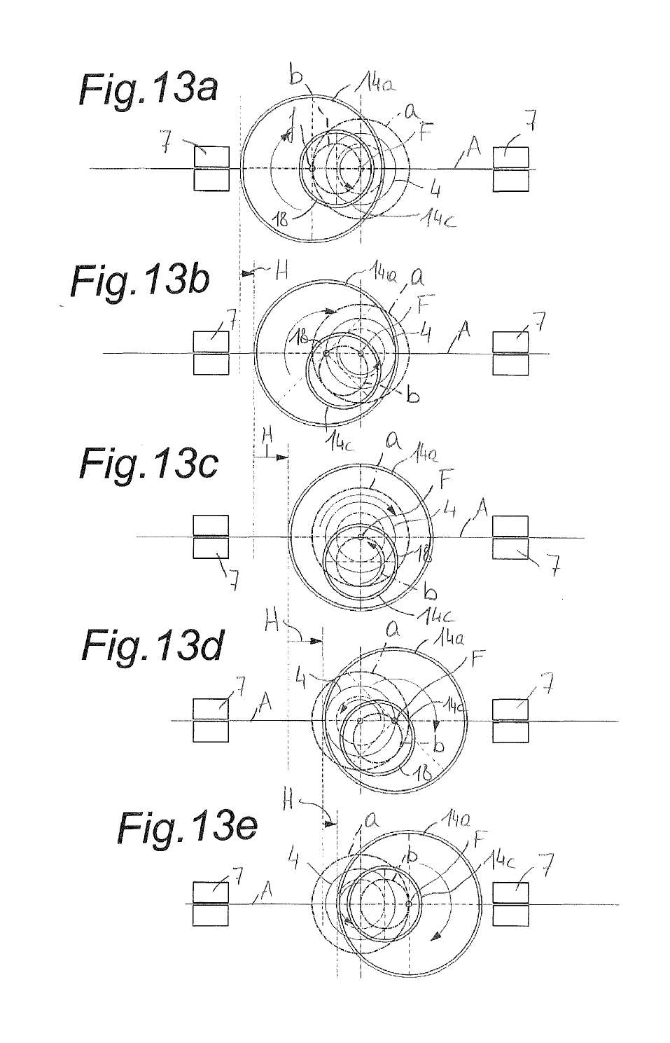

This geometric principle is applied in this disclosure, as shown in FIG. 12a-d and FIG. 13a-e. Each show an outer crankshaft journal 18 thusly arranged in the circular, eccentric recess 14c of transfer discs 14a, 14b, so that upon clockwise rotation of transfer discs 14a, 14b with simultaneous counterclockwise rotation of crankshaft 4, the crankshaft journal 18, the center G of the transfer disc 14a, 14b is displaced along a straight line. Ergo, the whole system of the transfer disc 14a, 14b with pressed-in crankshaft journal 18 moves along a line, the longitudinal axis B, C of the outer connecting rods 11a, 11b, which is parallel to the stroke axis A, when transfer disc 14a, 14b and crankshaft 4 are rotated in opposite directions.

Conversely, this also means that a movement of transfer disc 14a, 14b along longitudinal axes, B and C, forces transfer disc 14a, 14b and outer crankshaft journal 18 to turn against each other, thereby creating a rotational movement of crankshaft 4. This movement is translated to outer connecting rods 11a, 11b, where transfer discs 14a, 14b are set into an opening 11c in connecting rod 11b, which connects outer connecting rods 11a, 11b to outer crankshaft journal 18 in such a way that they can move.

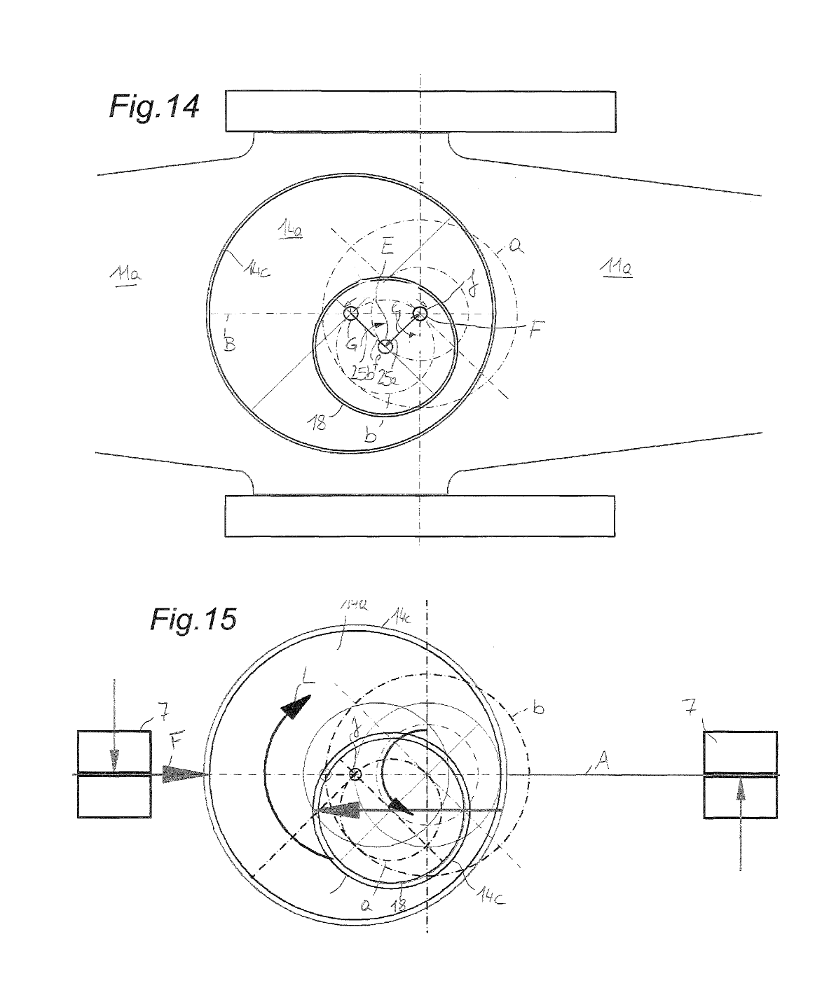

Analogously to the kinematic principle of the cardanic circles, a and b, the linear part of the disclosure can be represented by lever arms 25a, 25b as shown in FIG. 14: a first eccentricity e between axis, F, of crankshaft 4, and the center of a main bearing 24 and the rotation axis, E, of the outer crankshaft journal 18 represents a first lever arm 25a whose length is one quarter of stroke length, H. A second eccentricity, f, between the center, G, of transfer discs 14a, 14b and axis of rotation, E, of outer crankshaft journal 18 creates a second lever arm 15b, which also has one quarter of stroke length, H.

Crankshaft 4 has the same rotational speed as transfer discs 14a, 14b, but rotates in the opposite direction. In these conditions, center, G, of transfer discs 14a, 14b moves along a straight line.

One can better understand the representation of lever arms 25a, 25b with a depiction of the cardanic circles a, b, such that axis, F, of crankshaft 4 and the center of main bearing 24 lie in the central point, I, of the larger cardanic circle, a. The axis of rotation, E, of outer crankshaft journal 18 is in the center of the smaller cardanic circle, b. The center, G, of the transfer disc 14a, 14b is a reference point, J, for both cardanic circles, a, and b, in their exact centers. Over the course of the stroke, H, they move horizontally along the diameter of the larger cardanic circle, a.

Outer connecting rods 11a, 11b and outer piston 7 oscillate with harmonic movement. This means that the deflection of the outer connecting rods 11a, 11b and the outer piston 7 is sinusoidal.

A force, K, which is introduced by outer piston 7, exerts a torque, L, on crankshaft 4, and the force is absorbed by main bearing 24 and outer crankshaft bearing 19.

An analysis showed that the forces on the linear sliding bearing for one after the principle moving piston are smaller than in a crank mechanism with the rod length to eccentricity ratio of 10. (For car engines, a ratio of 3 to 3.5 is common.)

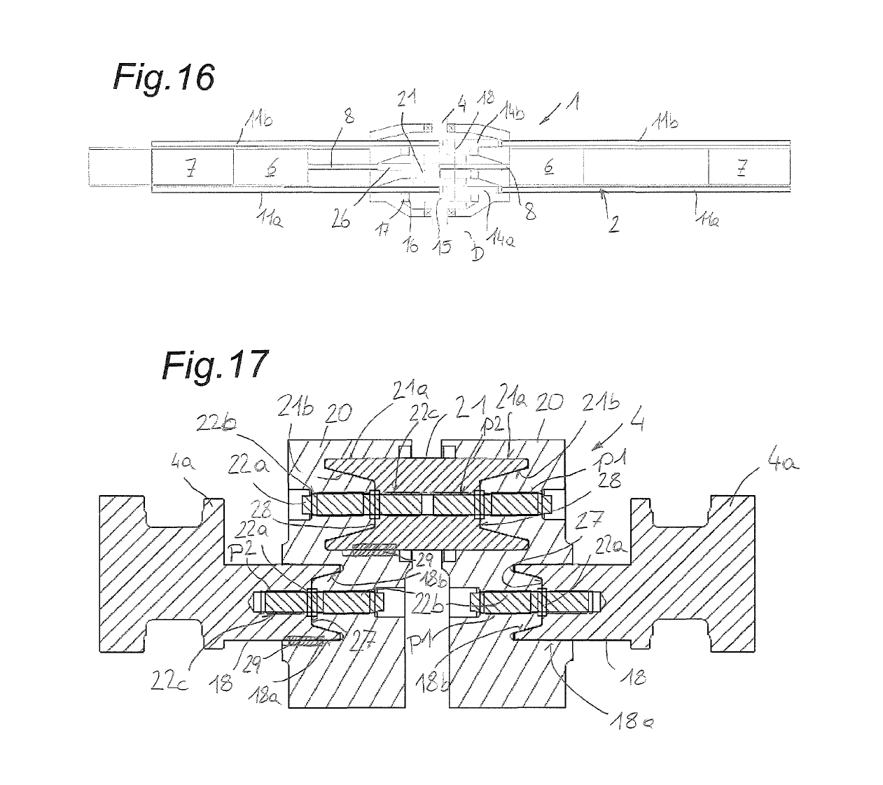

A third example is shown in FIG. 16, in which internal combustion engine 1 has a third transfer disc 26 to inner piston 6, which is coupled to two inner connecting rods 8. Inner connecting rods 8 are then arranged along the stroke axis, A; and are of one piece. Third transfer disc 26 rotates about inner crankshaft journal 18. The function is analogous to first transfer disc 14 and to the second transfer disc 14b.

As a result, this design can achieve the same advantages as outer pistons 7 and outer connecting rods 11a, 11b. Third transfer disc 26 has no outer teeth facing housing 5.

In a fourth example, shown in FIG. 17, the crankshaft is made up of multiple parts. In this example, outer crankshaft journals 18 and outer parts 4a of crankshaft 4 form a unit. Outer crankshaft journals 18 have a conical outer surface 18a that faces an external connecting surface 27. External connecting surface 27 is connected to outer surface 18a via a conical inner surface 18b. Inner crankshaft journal 21 has two inner connecting surfaces 28, with which it contacts crank arms 20. External connecting surfaces 27 are also located on recesses of crank arms 20, which are essentially of a corresponding shape to outer crankshaft journals 18.

Inner crankshaft journal 21 has an outer truncated conical surface 21a and an inner truncated conical surface 21b for each crank arm 20.

Crank arms 20 are connected to inner crankshaft journal 21 via stud bolts 22a. Stud bolts 22a each have a first section of thread 22b and a second section of thread 22c. The first section of thread 22b has thread pitch, p1, and the second section of thread 22c has thread pitch, p2, which in the example shown is twice as large as the first pitch, p1.

To connect crank arm 20 with inner crankshaft journal 21 and crank arm 20 with outer crankshaft journal 18, stud bolt 22a is installed with first thread 22c screwed into crank arm 20 up to a certain depth (in the example shown, about half of the engagement of second thread 22c at double first thread pitch p1). Then the respective crankshaft journal 18, 21 is in contact with the stud bolt 22a and second thread section 22c is screwed into crankshaft journals 18, 21. Crank arm 20 and crankshaft journal 18, 21 are brought closer to each other. Between the truncated conical surface 21a and crank arm 20 and between conical outer surface 18a and crank arm 20 there is an interference fit.

Conical outer surface 18a and outer truncated conical surface 21a, in the example shown, each have a pitch of less than 1°.

To ensure exact positioning of crankshaft journals 18, 21 to crank arms 20, there is an adjusting spring 29 provided for each connection between crankshaft journals 18, 21 and crank arm 20. This ensures that the tolerances for the angle of crankshaft 4 can be maintained exactly. Adjusting spring 29 is installed in each case between outer truncated conical surface 21a and crank arm 20 and between each conical outer surface 18a and crank arm 20.

Due to their first and second thread pitches, p1 and p2, being different, disassembly of crankshaft 4 is quite simple. Stud bolts 22a of crank arm 20 are removed. Crankshaft journals 18, 21 move away from crank arm 20 because of the larger second thread pitch, p2.

There is no contact between conical inner surface 18b and crank arm 20. Similarly, there is no contact between inner truncated conical surface 21b and crank arm 20. In the example shown, rounded surfaces between conical inner surface 18b and conical outer surface 18a do not touch crank arms 20. Analogously, the rounded surfaces between outer truncated conical surface 21a and inner truncated conical surface 21b do not touch crank arms 20.

Briefly summarized, the disclosure relates to an internal combustion engine 1 with at least one double cylinder 2, in which two inner pistons 6 and two outer pistons 7 are each connected by at least one inner connecting rod 8, a first outer connecting rod 11a, and a second outer connecting rod 11b, arranged in double cylinder 2 thus that they are moved back and forth by a crankshaft 4. A feature of the disclosed internal combustion engine 1 is that outer connecting rods 11a, 11b do not pivot. According to the disclosure, the lack of pivot of outer connecting rods 11a, 11b is fulfilled by the fact that outer connecting rods 11a, 11b are coupled to two outer pistons 7 are respectively coaxial and of one piece.

1-10. (canceled)

11. An internal combustion engine, comprising:
a double cylinder; and
two inner pistons and two outer pistons which reciprocate within the double cylinder wherein:
each of the two outer pistons are connected to a crankshaft by a first outer connecting rod and second outer connecting rod;
the first two outer connecting rods associated with the two outer pistons are coaxial and of one piece; and
the second two outer connecting rods associated with the two outer pistons are coaxial and of one piece.

12. The internal combustion engine of claim 11 wherein:
the first outer connecting rods are connected to the crankshaft via a first transfer disc;
the second outer connecting rods are connected to the crankshaft via a first transfer disc;
the first transfer disc and the second transfer disc are rotatable; and
the first transfer disc and the second transfer disc are eccentric with respect to an outer crankshaft journal of the crankshaft.

13. The internal combustion engine of claim 12 wherein:
a transfer disc gear with external teeth is installed eccentrically on the transfer disc;
external teeth engage with internal teeth of a ring gear; and
the ring gear is fixed to a housing.

14. The internal combustion engine of claim 13 wherein:
transfer disc gear with teeth has a gear ratio of 1:2 with respect to the ring gear with teeth.

15. The internal combustion engine of claim 11 wherein:
the first connecting rods are arranged on a first longitudinal axis;
the second outer connecting rods are arranged on a second longitudinal axis;
the outer pistons reciprocate along a stroke axis; and
the first longitudinal axis, the second longitudinal axis, and the stroke axis lie in a single plane.

16. The internal combustion of claim 11 wherein:
each of the outer pistons are connected via a T-shaped connecting element which couples between a first outer connecting rod and a second outer connecting rod;
the double cylinder includes a first cylinder and a second cylinder;
the first and second cylinders have outer guide recesses; and
the T-shaped connecting element is arranged with its two ends engaged with the outer guide recesses.

17. The internal combustion engine of claim 12 wherein:
the two inner connecting rods are connected via a third transfer disk to the crankshaft;
the third transfer disc is installed such that it can rotate with respect to the inner connecting rods; and
the third transfer disc is eccentric with respect to an inner crankshaft journal of the crankshaft.

18. The internal combustion engine of claim 11 wherein:
the crankshaft has an inner crank journal and two crank arms comprised of separate pieces;
the crank journal is disposed between the two crank arms;
the crank arms have conical surfaces; and
bolts pass through crank arms and engage with the inner crank journal.

19. The internal combustion engine of claim 11 wherein:
the crankshaft has an inner crank journal and two crank arms comprised of separate pieces;
the crank journal is disposed between the two crank arms;
the crank arms have conical surfaces;
stud bolts pass through crank arms and engage with the inner crank journal;
the stud bolt has a first section of thread with a first thread pitch and a second section of tread with a second thread pitch; and
the second thres pitch is greater than the first thread pitch.

20. An internal combustion engine, comprising:
a crankshaft having an axis of rotation;
a first cylinder having a central axis that is perpendicular to the axis of rotation of the rotation and disposed on one side of the crankshaft;
a second cylinder having a central axis that is collinear with the central axis of the first cylinder;
the second cylinder is arranged on the opposite side of the crankshaft than the first cylinder;
a first inner piston and a first outer piston disposed in the first cylinder;
a second inner piston and a second outer piston disposed in the second cylinder; and
each of the first and second outer pistons is connected to the crankshaft via first outer connecting rods and second outer connecting rods wherein:
the first outer connecting rods associated with the two outer pistons are coaxial and of one piece; and
the second two outer connecting rods associated with the two outer pistons are coaxial and of one piece.

21. The internal combustion of claim 20 wherein:
each of the outer pistons are connected via a T-shaped connecting element which couples between the first outer connecting rod and the second outer connecting rod;
each of the first and second cylinders have a pair of outer guide recesses; and
the T-shaped connecting elements are arranged with their two ends engaged with the outer guide recesses such that bearing surfaces of the T-shaped connecting elements slide along the outer guide recesses during reciprocation of the outer pistons.

22. The internal combustion engine of claim 20 wherein:
the first outer connecting rods are connected to the crankshaft via a first transfer disc; and
the second outer connecting rods are connected to the crankshaft via a first transfer disc.

23. The internal combustion engine of claim 22 wherein:
the first transfer disc and the second transfer disc are rotatable; and
the first transfer disc and the second transfer disc are eccentric with respect to an outer crankshaft journal of the crankshaft.

24. The internal combustion engine of claim 23 wherein:
a transfer disc gear with external teeth is installed eccentrically on the first and second transfer discs;
the external teeth of the first and second transfer discs engage with internal teeth of a ring gear;
transfer disc gear with teeth has a gear ratio of 1:2 with respect to the ring gear with teeth; and
the ring gear is fixed to a housing of the internal combustion engine.

25. The internal combustion engine of claim 20 wherein:
the crankshaft has an inner crank journal and two crank arms comprised of separate pieces;
the crank journal is disposed between the two crank arms; and
bolts pass through crank arms and engage with the inner crank journal.

26. The internal combustion engine of claim 25 wherein: the crank arms have conical surfaces.
